(19) United States
(12) Patent Application Publication
(10) Pub. No.: US 2012/0239253 A1
(43) Pub. Date: Sep. 20, 2012

(54) METHOD FOR OPERATING A DRIVER ASSISTANCE SYSTEM AND DRIVER ASSISTANCE SYSTEM

(75) Inventors: Gerald SCHMIDT, Frankfurt am Main (DE); Markus ARMBRUST, Wonsheim (DE)

(73) Assignee: GM GLOBAL TECHNOLOGY OPERATIONS LLC, Detroit, MI (US)

(21) Appl. No.: 13/419,560

(22) Filed: Mar. 14, 2012

(30) Foreign Application Priority Data
Mar. 16, 2011 (DE) 10 2011 014 083.2

(51) Int. Cl. G06F 7/00; B62D 6/00; B60T 8/17

(52) U.S. Cl. 701/41; 701/36; 701/70

(57) ABSTRACT

A method is provided for operating a driver assistance system of a motor vehicle that includes, but is not limited to determining a parameter characterizing a traffic density in an area of the environment of the motor vehicle, determining a degree of the traffic density based on the parameter, and adapting a threshold value of the driver assistance system for an automatic actuation of at least one element of the motor vehicle, such as a braking apparatus, a drive apparatus, a steering apparatus, and a warning apparatus, as a function of the determined degree of traffic density. Additionally or alternatively, a degree of actuation of the at least one element is adapted as a function of the determined degree of the traffic density.

### CROSS-REFERENCE TO RELATED APPLICATION

This application claims priority to German Patent Application No. 10 2011 014 083.2, filed Mar. 16, 2011, which is incorporated herein by reference in its entirety.

### DESCRIPTION

The technical field relates to a method for operating a driver assistance system of a motor vehicle, a driver assistance system, a computer program product, and a computer-readable medium.

### BACKGROUND

Known from DE 10 2008 062 796 A1 is a method for operating a vehicle and a driver assistance system using the method. The method involves detecting a surrounding situation in an environment in the direction of travel of the vehicle by means of a detection means. A processing unit determines a value field from the surrounding situation. A value of the value field at a point of the value field corresponds to an obstacle value at a corresponding point in the environment of the vehicle. A guide for the vehicle, for example, a longitudinal and a transverse guide, is then automatically determined by the processing unit in a field in the driving direction ahead of the vehicle as a function of the value fields.

It is at least one object to provide a method for operating a driver assistance system of a motor vehicle, a driver assistance system for a motor vehicle, a computer program product, and a computer-readable medium, which makes it possible for the driver assistance system to make improved allowance for an instantaneous traffic situation. In addition, other objects, desirable features and characteristics will become apparent from the subsequent summary and detailed description, and the appended claims, taken in conjunction with the accompanying drawings and this background.

### SUMMARY

According to an embodiment, a method for operating a driver assistance system of a motor vehicle comprises at least one parameter characterizing a traffic density in an area of an environment of the motor vehicle is determined. In addition, the method comprises determining a degree of the traffic density based on the at least one determined parameter. A threshold value of the driver assistance system is furthermore adapted for an automatic actuation of at least one element of the motor vehicle, selected from the group consisting of a braking apparatus, a drive apparatus, a steering apparatus, and a warning apparatus as a function of the determined degree of traffic density. Additionally or alternatively to the last-mentioned step, a degree of actuation of the at least one element is adapted as a function of the determined degree of the traffic density.

The method for operating a driver assistance system according to the embodiment makes it possible for the driver assistance system to make improved allowance for an instantaneous traffic situation. This is accomplished by adapting the threshold value for an automatic actuation of at least one of the said elements of the motor vehicle or by adapting a degree of actuation of the at least one element in each case as a function of the determined degree of traffic density. The instantaneous traffic situation is thereby taken into account when operating the driver assistance system in the form of the determined degree of traffic density. As a result, for example, the number of warning messages output by the driver assistance system, which are perceived by a driver of the motor vehicle as unnecessary or absent, which is false positive or false negative warning messages, can be reduced. The acceptance of the driver assistance system by occupants of the motor vehicle, in particular by the driver of the motor vehicle, is thereby additionally advantageously increased.

Determining the at least one parameter can include determining a number of motor vehicles on a pre-determined path unit. The at least one parameter thus characterizes a so-called static traffic density, for example, the number of motor vehicles per kilometer. At the same time, the number of motor vehicles is preferably determined relative to the particular lane, that is, the number of motor vehicles per lane and for example, per kilometer is determined. Furthermore, determining the at least one parameter can additionally or alternatively include determining an average speed of other motor vehicles relative to the motor vehicle. In this case, the at least one parameter characterizes a so-called dynamic traffic density, wherein in particular motor vehicles are also taken into account in lanes adjacent to the lane in which the motor vehicle is traveling. In both the aforesaid embodiment, a parameter characterizing the traffic density in the environment of the motor vehicle is determined as accurately as possible.

In a further embodiment, the driver assistance system is selected from the group consisting of an emergency braking system, a braking assistant, and a first collision warning system. In this embodiment, adapting the threshold value of the driver assistance system for the automatic actuation of the at least one element is preferably accomplished in such a manner that a warning message output with the warning apparatus is output at a later time point when the degree of the traffic density is high than when the degree of the traffic density is low. This embodiment starts from the consideration that in the driver assistance systems that each take into account the traffic situation in the direction of travel of the motor vehicle, that is in the longitudinal direction, it is advantageous to output a warning message at a later time point when the degree of traffic density is high since the motor vehicle in these situations usually has shorter distances from neighboring motor vehicles. A low selected threshold value for the automatic actuation would therefore result in an increased number of warning messages, which could be perceived by the occupants of the motor vehicle, in particular by the driver of the motor vehicle, as troublesome.

In a further embodiment, the driver assistance system is selected from the group consisting of a lane departure warning system and a second collision warning system. In this embodiment, adapting the threshold value of the driver assistance system for the automatic actuation of the at least one element is accomplished in such a manner that a warning message output with the warning apparatus is output at an earlier time point when the degree of the traffic density is high than when the degree of the traffic density is low. This embodiment starts from the consideration that in the driver assistance systems which each take into account the instantaneous traffic situation transversely to the direction of travel of the motor vehicle that is in the lateral direction, it is advantageous to output a warning message at an earlier time point when the degree of traffic density is high. In this situation, an increased number of motor vehicles are located in the immediate vicinity of the motor vehicle, with the result that an unintentional departure from one's own lane can constitute a more dangerous situation than when the degree of traffic density is lower.

In a further embodiment, the driver assistance system is configured as a distance regulating system. In this embodiment, the adaptation of the degree of actuation includes adapting a tolerance limit of a regulating difference for the distance regulation, which is adapting a tolerance limit for a deviation of the actual value of the distance to be regulated from the desired value of the distance. The tolerance limit of the regulating difference is preferably adapted in such a manner that the motor vehicle more directly follows another motor vehicle determined as target vehicle for the distance regulation when the degree of traffic density is high. The tolerance limit of the regulating difference is therefore lower at a high degree of traffic density than at a lower degree of traffic density.

In a further embodiment of the method, a category of a road being traveled upon instantaneously by the motor vehicle is additionally determined. In this embodiment, the adaptation of the threshold value and/or the degree of actuation is additionally made as a function of the determined category of the road. The instantaneous traffic situation can be taken into account to a further increased extent for the driver assistance system.

The category of the road is preferably determined with map data stored in a memory apparatus and/or by means of at least one sensor of the motor vehicle and/or by means of data received by a receiving apparatus. The receiving apparatus is in this case part of a vehicle-to-vehicle communication apparatus and/or a vehicle-to-infrastructure communication apparatus of the motor vehicle. The types of determination allow a reliable determination of the road category.

Additionally or alternatively, at least one parameter characterizing a driving behavior of a momentary driver of the motor vehicle can be additionally determined. In this embodiment, the adaptation of the threshold value and/or the degree of actuation is additionally made as a function of a driving behavior of the momentary driver determined on the basis of the at least one parameter. As a result, the driver assistance system can be adapted to an increased extent to the driving behavior of the driver of the motor vehicle. This in turn advantageously increases the acceptance of the driver assistance system. The at least one parameter is preferably selected from the group consisting of a braking behavior of the driver, an acceleration behavior of the driver, a steering behavior of the driver, an adjustment of a chassis control and an adjustment of a driving system control. The parameters are especially suitably for determining the driving behavior of the driver.

The application additionally relates to a driver assistance system for a motor vehicle, where the driver assistance system comprises a first determination apparatus configured to determine at least one parameter characterizing a traffic density in an area of an environment of the motor vehicle. The driver assistance system further comprises a second determination apparatus configured to determine a degree of the traffic density based on the at least one determined parameter. Furthermore, the driver assistance system has an adaptation apparatus. The adaptation apparatus is configured to adapt a threshold value of the driver assistance system for an automatic actuation of at least one element of the motor vehicle, selected from the group consisting of a braking apparatus, a drive apparatus, a steering apparatus, and a warning apparatus as a function of the determined degree of traffic density. Additionally or alternatively, the adaptation apparatus is configured to adapt a degree of actuation of the at least one element as a function of the determined degree of the traffic density.

A motor vehicle is provided having a driver assistance system according to the said embodiment. The motor vehicle is, for example, an automobile or a truck. The driver assistance system and the motor vehicle have at least the advantages already mentioned in connection with the method, which are not listed again at this point to avoid repetitions. In addition, a computer program product is provided that when executed on a processing unit of a driver assistance system of a motor vehicle, instructs the processing unit to carry out the following steps. The processing unit is instructed to determine at least one parameter characterizing a traffic density in an area of the environment of the motor vehicle. The processing unit is further instructed to determine a degree of the traffic density based on the at least one determined parameter. Furthermore the processing unit is instructed to adapt a threshold value of the driver assistance system for an automatic actuation of at least one element of the motor vehicle, selected from the group consisting of a braking apparatus, a drive apparatus, a steering apparatus, and a warning apparatus as a function of the determined degree of traffic density. Additionally or alternatively, the processing unit is instructed to adapt a degree of actuation of the at least one element as a function of the determined degree of the traffic density.

A computer-readable medium is provided on which a computer program product according to the said embodiment is stored. The computer program product and the computer-readable medium have the advantages already mentioned in connection with the method, which are not listed again at this point to avoid repetitions.

### BRIEF DESCRIPTION OF THE DRAWINGS

The present invention will hereinafter be described in conjunction with the following drawing figures, wherein like numerals denote like elements, and:

FIG. 1 shows a flow diagram of a method for operating a driver assistance system of a motor vehicle according to a first embodiment;

FIG. 2 shows a flow diagram of a method for operating a driver assistance system of a motor vehicle according to a second embodiment;

FIG. 3 shows an example of a traffic situation in which the method according to the application can be used;

FIG. 4 shows a driver assistance system of the first motor vehicle shown in FIG. 3 according to a first embodiment; and

FIG. 5 shows a driver assistance system of the first motor vehicle shown in FIG. 3 according to a second embodiment.

### DETAILED DESCRIPTION

The following detailed description is merely exemplary in nature and is not intended to limit application and uses. Furthermore, there is no intention to be bound by any theory presented in the preceding background or summary or the following detailed description.

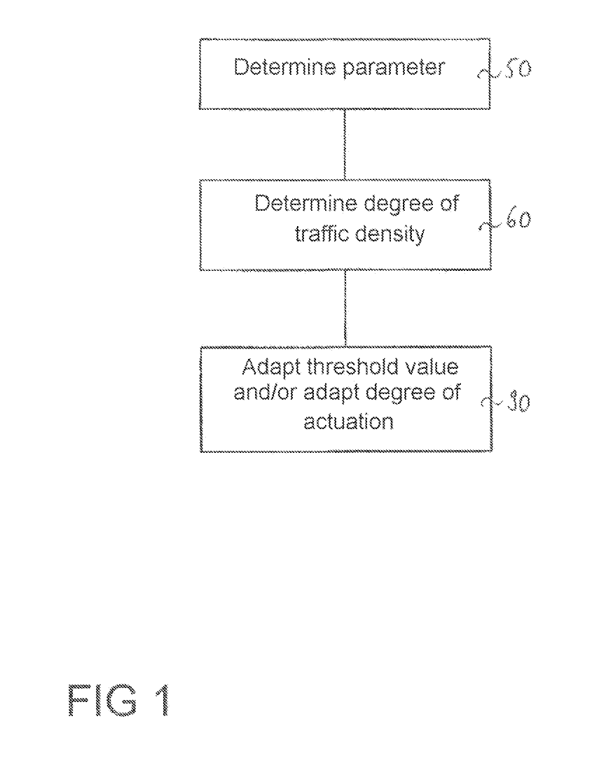

FIG. 1 shows a flow diagram of a method for operating a driver assistance system of a motor vehicle according to a first embodiment. The motor vehicle, for example, is an automobile or a truck. In a step 50 at least one parameter characterizing a traffic density in an area of the environment of the motor vehicle is determined. The determination of the at least one parameter can include determining a number of motor vehicles on a predetermined path unit and/or determining an average speed of other motor vehicles relative to the motor vehicle. The at least one parameter preferably characterizes the traffic density in an area of the environment of the motor vehicle located in front of the motor vehicle in the direction of travel and/or laterally adjacent to the motor vehicle.

In a step 60 a degree of the traffic density is determined based on the at least one determined parameter. If the determination of the at least one parameter in step 50 includes determining a number of motor vehicles on a predetermined path unit, a degree of static traffic density is thus determined in step 60. If the determination of the at least one parameter includes determining an average speed of other motor vehicles relative to the motor vehicle, a degree of dynamic traffic density is thus determined in step 60.

In a step 90, a threshold value of the driver assistance system is adapted for an automatic actuation of at least one element of the motor vehicle, selected from the group consisting of a braking apparatus, a drive apparatus, a steering apparatus, and a warning apparatus as a function of the determined degree of traffic density. Additionally or alternatively in step 90, a degree of actuation of the at least one element can be adapted as a function of the determined degree of the traffic density.

In the embodiment shown, the driver assistance system can be selected from the group consisting of an emergency braking system, a braking assistant, and a first collision warning system. In the said driver assistance systems, adapting the threshold value of the driver assistance system for the automatic actuation of the at least one element is accomplished in step 90 in such a manner that a warning message output with the warning apparatus is output at a later time point when the degree of the traffic density is high than when the degree of the traffic density is low or in such a manner that the braking apparatus is actuated at a later time point when the degree of traffic density is high than at a low degree of traffic density. The adaptation of the threshold value is additionally accomplished in such a manner that the output of the warning message or the actuation of the braking apparatus takes place at the latest at a predetermined time when the degree of traffic density is high. As a result, the occupants of the motor vehicle, in particular the driver of the motor vehicle, are alerted to the particular traffic situation in good time or the automatic braking process is initiated. In the said driver assistance systems, the threshold value is also designated as TTC value (Time to Collision).

Furthermore, the driver assistance system can be selected from the group consisting of a lane departure warning system and a second collision warning system. In these driver assistance systems, adapting the threshold value of the driver assistance system for the automatic actuation of the at least one element in step 90 is accomplished in such a manner that a warning message output by means of the warning apparatus is output at an earlier time point when the degree of the traffic density is high than when the degree of the traffic density is low or in such a manner that an actuation of the braking apparatus and/or the steering apparatus when the degree of traffic density is high takes place at an earlier time than when the degree of traffic density is low. Furthermore, the driver assistance system can be configured as a distance regulating system. The adaptation of the degree of actuation in step 90 includes adapting a tolerance limit of a regulating difference for the distance regulation.

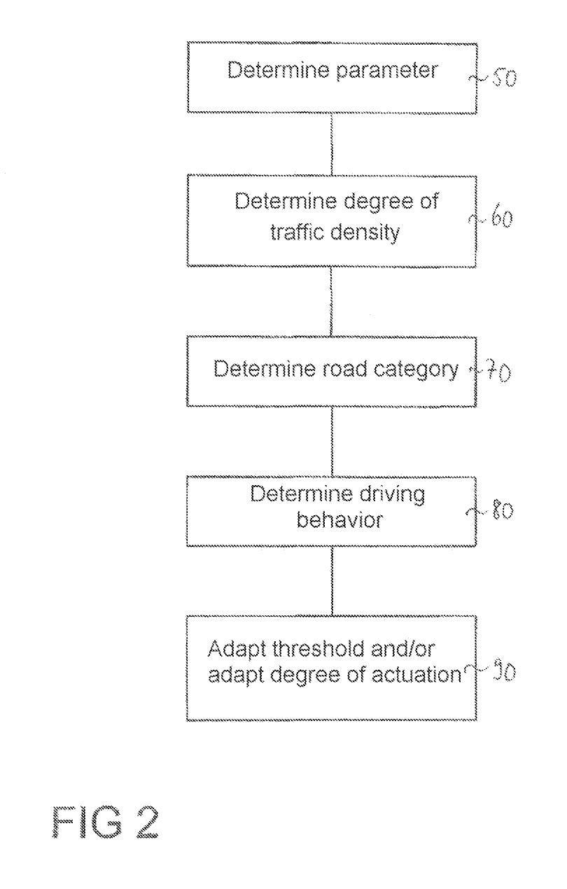

FIG. 2 shows a flow diagram of a method for operating a driver assistance system of a motor vehicle according to a second embodiment. The motor vehicle is, for example, again an automobile or a truck. In the embodiment shown, in a step 50 at least one parameter characterizing a traffic density in an area of the environment of the motor vehicle is determined and in a step 60 a degree of the traffic density is determined based on the at least one determined parameter, corresponding to steps 50 and 60 of the first embodiment shown in FIG. 1.

In addition, in a step 70 a category of a road being traveled upon instantaneously by the motor vehicle is additionally determined. In this case, the category of the road can be determined by means of map data stored in a memory apparatus and/or by means of at least one sensor of the motor vehicle, for example, with at least one optical camera. Furthermore, the category of the road can be determined with data received by a receiving apparatus, where the receiving apparatus is part of a vehicle-to-vehicle communication apparatus and/or a vehicle-to-infrastructure communication apparatus of the motor vehicle.

In a step 80, at least one parameter characterizing a driving behavior of a momentary driver of the motor vehicle is additionally determined. The at least one parameter is preferably selected from the group consisting of a braking behavior of the driver, an acceleration behavior of the driver, a steering behavior of the driver, an adjustment of a chassis control and an adjustment of a driving system control. The chassis control is also designated as DMC (Dynamic Mode Control) and the driving system control is designated as interactive dynamic driving system or Flex Ride. The determination of the at least one parameter characterizing the driving behavior of the momentary driver of the motor vehicle can also take place before determining the category of the road, that is, steps 70 and 80 can be executed in reverse order.

In a step 90 a threshold value of the driver assistance system is adapted for an automatic actuation of at least one element of the motor vehicle, selected from the group consisting of a braking apparatus, a drive apparatus, a steering apparatus, and a warning apparatus as a function of the determined degree of traffic density, and/or a degree of actuation of the at least one element is adapted as a function of the determined degree of the traffic density according to the first embodiment shown in FIG. 1. At the same time, the adaptation of the threshold value and/or the degree of actuation in the second embodiment of the method shown in FIG. 2 additionally takes place as a function of the determined category of the road and a function of a driving behavior of the momentary driver determined on the basis of the at least one parameter.

The adaptation of the threshold value is preferably accomplished in such a manner than on smaller roads, for example, in town, shorter distances from longitudinally adjacent motor vehicles are possible, that is in such a manner that a warning message is output at a later time. If, on the other hand, it is determined that the motor vehicle is located instantaneously on a freeway, the threshold value is adapted in such a manner that a warning message is output at an earlier time. The threshold value can also be adapted in such a manner that when sporty or dynamic driving behavior of the momentary driver is determined, a warning message is output at a later time whereas in the case of comfortable driving behavior of the momentary driver, the warning message is output at an earlier time.

In the embodiment shown, data from ambient sensor systems, for example, a front camera, a radar or a vehicle-to-vehicle communication system, which is also designated as V2V system (vehicle to vehicle), and additionally digital map data are analyzed over a certain period of time in order to determine the traffic situation for a longer-term calibration of an MMI time control (MMI, man-machine interface). The type of road, a speed restriction, and a width of the lane can be determined with the map data and/or lane sensors. By means of data determined by object sensors, it can be determined how many other road users are located in the surroundings of the motor vehicle as well as a TTC value (TTC, time to collision) and an HT value (HT, headway time or time following distance).

A “sport/tour” switching element can be used as another source for longer-term driving behavior or driving style information. Other sources of information from chassis systems, which provide shorter-term vehicle dynamic information such as, for example, data determined with dynamic mode control and driver control information such as, for example, brake pedal, accelerator pedal, and steering wheel information and the like can additionally be taken into account in the method. These parameters provide short-term information about the instantaneous driving situation.

The time control of the driver assistance system, that is lower allowed minimum TTC values and HT values for longitudinal assistance systems and earlier warnings for lateral assistance systems in traffic determined to be dense, and an intensity of the actions, for example, harder braking interventions, can be adapted by the analysis described above in order to allow for the traffic and driving situation. Such a calibration of the MMI timing can be provided, for example for ACC (adaptive cruise control), FCA (forward collision alert), tailgating warning and LDW (lane departure warning) systems The time of outputting warning messages or the intensity of actions, in the case of the ACC system a stronger or weaker braking, can be improved since they fulfill the expectations of the driver of the motor vehicle, which leads to a higher customer acceptance. The number of warning messages which are perceived by the driver of the motor vehicle as unnecessary or absent (false positive/false negative) in driver assistance systems can also be reduced.

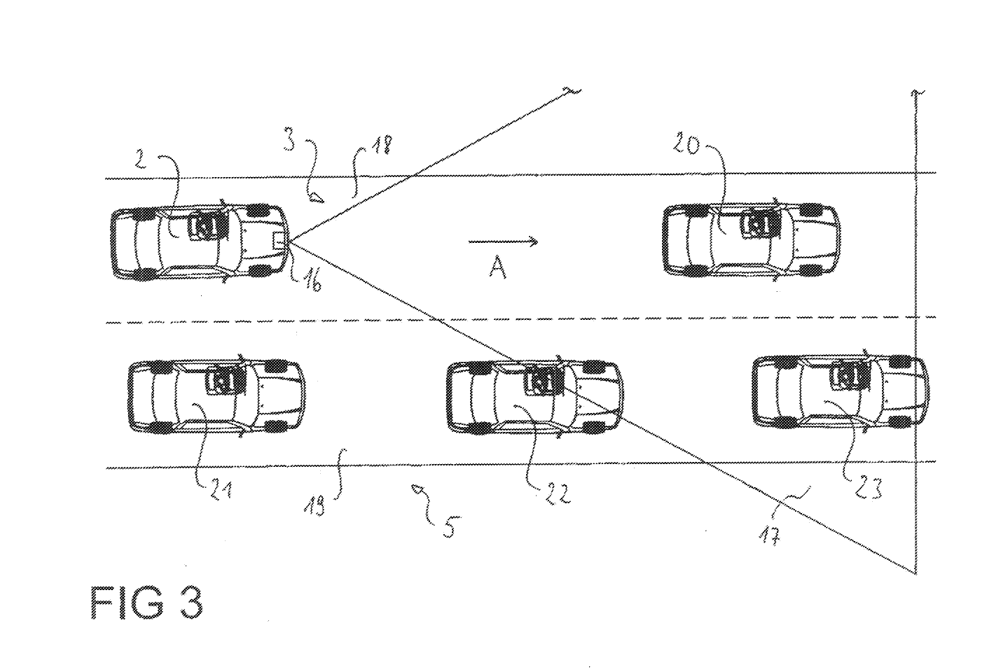

FIG. 3 shows an example of a traffic situation in which the method according to embodiments, in particular according to the embodiments shown in FIG. 1 and FIG. 2, can be used. In the traffic situation shown a first motor vehicle 2, that in the embodiment shown is an automobile, is traveling in a direction of travel shown schematically with an arrow A in a first lane 18 of a road 5. In addition to the first lane 18, the road 5 has another lane 19 in the direction of travel of the first motor vehicle 2 and is, for example, a highway or a freeway. In the direction of travel of the first motor vehicle 2, a second motor vehicle 20 is traveling in front of this in the first lane 18. In the second lane 19, motor vehicles 21, 22, and 23 are traveling in the direction of travel of the first motor vehicle 2. The motor vehicles 20 to 23 are also automobiles in the embodiment shown.

Of the automobiles, the motor vehicle 20, the motor vehicle 22, and the motor vehicle 23, are located at least partially within a schematically depicted detection range 17 of a sensor 16 of the first motor vehicle 2. In the embodiment shown the sensor 16 is an electromagnetic sensor, for example, a radar sensor, a lidar sensor, or an optical camera. With measurement data determined by the sensor 16, the motor vehicles can be detected and their speed determined relative to the first motor vehicle 2. A degree of traffic density in an area of an environment 3 of the first motor vehicle 2 can be determined from these parameters. As is explained in detail in connection with the following figures, the determined degree of traffic density can be taken into account for driver assistance systems of the first motor vehicle 2.

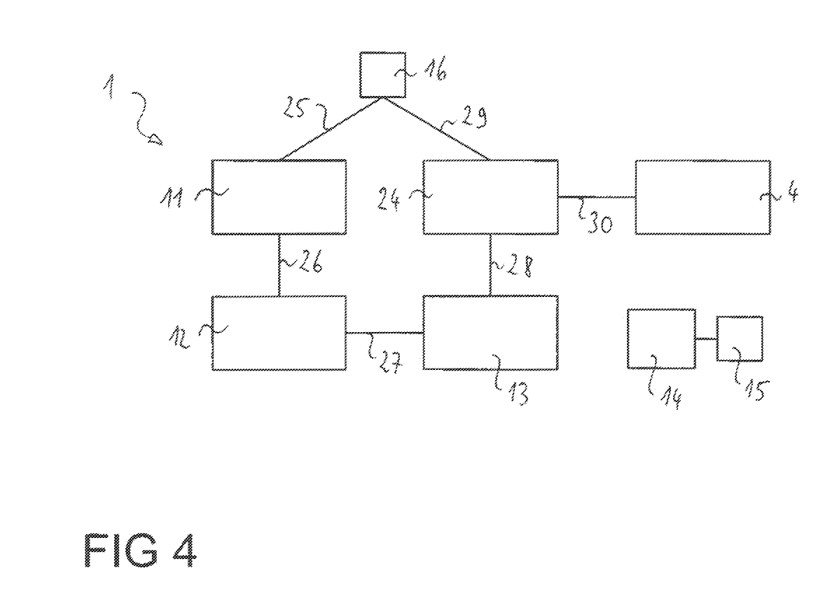

To this end, FIG. 4 shows a driver assistance system 1 of the first motor vehicle shown in FIG. 3 according to a first embodiment. Components having the same functions as in FIG. 3 are characterized by the same reference numbers and not explained again in the following. The driver assistance system 1 comprises a first determination apparatus 11, which is configured to determine at least one parameter characterizing a traffic density in an area of an environment of the first motor vehicle. To this end the first determination apparatus 11 is connected via a signal line 25 to the sensor 16.

Furthermore, the driver assistance system 1 comprises a second determination apparatus 12, which is configured to determine a degree of traffic density based on the at least one determined parameter. To this end the second determination apparatus 12 is connected to the first determination apparatus 11 via a signal line 26. In addition, the driver assistance system 1 has an adaptation apparatus 13. In the embodiment shown the adaptation apparatus is configured to adapt a threshold value of the driver assistance system 1 for an automatic actuation of at least one element 4 of the first motor vehicle as a function of the determined degree of traffic density. The element 4 is thereby selected from the group consisting of a braking apparatus, a drive apparatus, a steering apparatus, and a warning apparatus of the first motor vehicle. Furthermore, in the embodiment shown the adaptation apparatus 13 is configured to adapt a degree of actuation of the at least one element 4 as a function of the determined degree of traffic density. To this end the adaptation apparatus 13 is connected via a signal line 27 to the second determination apparatus 12 and via a signal line 28 to the control unit 24 of the driver assistance system 1. The control unit 24 actuates the at least one element 4 of the first motor vehicle via a control and signal line 30. Furthermore, the control unit 24 is connected to the sensor 16 via a signal line 29.

In addition, in the embodiment shown the driver assistance system 1 has a processing unit 14 and a computer-readable medium 15 where a computer program product is stored on the computer-readable medium 15 which, when executed on the processing unit 14, instructs the processing unit 14 to implement the steps mentioned in connection with the embodiments of the method, in particular the steps according to the first embodiment shown in FIG. 1, by means of the elements mentioned in this case. To this end, the processing unit 14 is connected directly or indirectly to the corresponding elements in a manner not shown in detail.

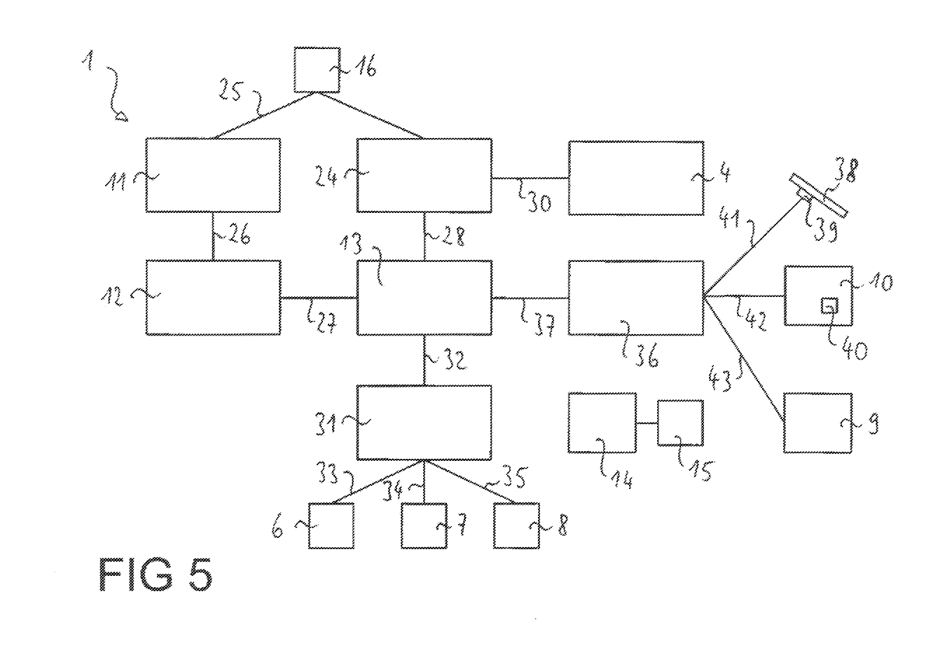

FIG. 5 shows a driver assistance system 1 of the first motor vehicle shown in FIG. 3 according to a second embodiment. Components having the same functions as in FIG. 4 are characterized with the same reference numbers and not explain again hereinafter. In addition to the first determination apparatus 11, the second determination apparatus 12, the adaptation apparatus 13, and the control unit 24, the driver assistance system 1 in the second embodiment has a third determination apparatus 31, which is configured to determine a category of a road instantaneously being traveled upon by the first motor vehicle. To this end, the third determination apparatus 31 is connected via a signal line 33 to a memory device 6, in which map data are stored. The memory device 6 is, for example, part of a navigation system of the first motor vehicle, Furthermore, the third determination apparatus 31 is connected via a signal line 34 to another sensor 7 of the first motor vehicle, for example, an optical camera. The category of the road can thereby be determined with images recorded by the optical camera. In addition, the third determination apparatus 31 is connected via a signal line 35 to a receiving apparatus 8, where the receiving apparatus 8 is part of a vehicle-to-vehicle communication apparatus or a vehicle-to-infrastructure communication apparatus of the first motor vehicle. The third determination apparatus 31 is furthermore connected to the adaptation apparatus 13 via a signal line 32.

In addition, the driver assistance system 1 has a fourth determination apparatus 36 that is configured to determine a driving behavior of a momentary driver of the first motor vehicle. To this end, the fourth determination apparatus 36 is connected via a signal line 41 to a sensor 39, which is configured to determine a degree of depression of an accelerator pedal 38 of the first motor vehicle. In addition, the fourth determination apparatus 36 is connected via a signal line 42 to a driving system control 10. The driving system control 10, also designated as interactive dynamic driving system or Flex Ride, has a control element 40 in the form of a so-called sport/tour operating element. In the embodiment shown, the driving system control 10 is configured to adapt an electronic shock absorber regulation, an engine characteristic or a characteristic of the accelerator pedal 38, and a steering support as a function of the setting selected by means of the control element 40. In addition, the fourth determination apparatus 36 is connected via a signal line 43 to a chassis control 9, which is also designated as dynamic mode control. The fourth determination apparatus 36 is connected via a signal line 37 to the adaptation apparatus 13.

In the second embodiment of the driver assistance system 1, the adaptation apparatus 13 is configured to adapt a threshold value of the driver assistance system 1 and to adapt the degree of actuation of the at least one element 4 as a function of the determined degree of traffic density and as a function of the determined category of the road and as a function of the determined driving behavior of the momentary driver of the first motor vehicle. In addition, the driver assistance system 1 has a processing unit 14 and a computer-readable medium 15 where a computer program product is stored on the computer-readable medium 15 which, when executed on the processing unit 14, instructs the processing unit 14 to implement the steps mentioned in connection with the embodiments of the method, in particular the steps of the method according to FIG. 2, by means of the elements mentioned in this case. To this end, the processing unit 14 is connected directly or indirectly to the corresponding elements in a manner not shown in detail.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for operating a driver assistance system of a motor vehicle, comprising:
determining a parameter characterizing a traffic density in an area of an environment of the motor vehicle;
determining a degree of the traffic density based at least in part on the parameter;
adapting a threshold value for an automatic actuation of an element of the motor vehicle; and
adapting a degree of actuation of the element as a function of the degree of the traffic density.

2. The method according to claim 1, wherein the element is a braking apparatus.

3. The method according to claim 1, wherein the element is a drive apparatus.

4. The method according to claim 1, wherein the element is a steering apparatus.

5. The method according to claim 1, wherein the element is a warning apparatus.

6. The method according to claim 1, wherein the determining the parameter includes comprises a number of motor vehicles on a pre-determined path unit.

7. The method according to claim 1, wherein the determining the parameter comprises determining an average speed of other motor vehicles relative to the motor vehicle.

8. The method according to claim 1, wherein the driver assistance system is an emergency braking system.

9. The method according to claim 1, wherein the driver assistance system is a braking assistant.

10. The method according to claim 1, wherein the driver assistance system is a first collision warning system.

11. The method according to claim 5, wherein the adapting the threshold value of the driver assistance system for the automatic actuation of the element comprises generating a warning message with the warning apparatus at a later time when the degree of the traffic density is high than when the degree of the traffic density is low.

12. The method according to claim 1, wherein the driver assistance system is a lane departure warning system.

13. The method according to claim 1, wherein the driver assistance system is a second collision warning system.

14. The method according to claim 1, wherein the adapting the degree of actuation comprises adapting a tolerance limit of a regulating difference for distance regulation.

15. The method according to claim 1, further comprising determining a category of a road being traveled upon by the motor vehicle,
wherein the adapting the threshold value is additionally made as a second function of the category of the road.

16. A computer readable medium embodying a computer program product, said computer program product comprising:
an operating program for operating a driver assistance system of a motor vehicle, the operating program configured to:
determine a parameter characterizing a traffic density in an area of an environment of the motor vehicle;
determine a degree of the traffic density based at least in part on the parameter;
adapting a threshold value for an automatic actuation of an element of the motor vehicle; and
adapt a degree of actuation of the element as a function of the degree of the traffic density.

17. The method according to claim 16, wherein the operating program is further configured to determine an average speed of other motor vehicles relative to the motor vehicle.

18. A driver assistance system for a motor vehicle, comprising:
a first determination apparatus configured to determine a parameter characterizing a traffic density in an area of an environment of the motor vehicle;
a second determination apparatus configured to determine a degree of the traffic density based on the parameter; and
an adaptation apparatus configured to adapt a threshold value of the driver assistance system for an automatic actuation of an element of the motor vehicle as a function of the degree of the traffic density.

19. The driver assistance system according to claim 18, wherein the adaptation apparatus is a braking apparatus.

20. The driver assistance system according to claim 18, wherein the adaptation apparatus is a warning apparatus.
